(19) United States
(12) Patent Application Publication
(10) Pub. No.: US 2014/0192052 A1
(43) Pub. Date: Jul. 10, 2014

(54) 2D RENDERING ON 3D GRAPHICS HARDWARE

(71) Applicant: Brian K. Bennett, Westborough, MA (US)

(72) Inventor: Brian K. Bennett, Westborough, MA (US)

(73) Assignee: Advanced Micro Devices, Inc., Sunnyvale, CA (US)

(21) Appl. No.: 13/738,442

(22) Filed: Jan. 10, 2013

Related U.S. Application Data
(60) Provisional application No. 61/750,628, filed on Jan. 9, 2013.

(51) Int. Cl. G06F 15/80

(52) U.S. Cl. CPC G06F 15/8007
USPC 345/426

(57) ABSTRACT

An apparatus, computer readable medium, and method of rendering a 2D object using a 3D graphics processing unit (GPU). The method includes one or more shaders running on the 3D GPU forming a 3D object by accessing the 2D object. The method may include the one or more shaders forming the 3D object by forming a plurality of 3D vertex attributes of the 2D object. The 3D vertex attributes may include position, color, and texture. The method may include copying a plurality of the 2D objects from a central processing memory (CPU) to a GPU memory. The one or more shaders may access the 2D object from the GPU memory.

### CROSS REFERENCE TO RELATED APPLICATIONS

This application claims the benefit of U.S. provisional application No. 61/750,628 filed Jan. 9, 2013, the contents of which are hereby incorporated by reference as if fully set forth herein.

### FIELD OF THE INVENTION

The present invention is generally directed to 2D rendering on 3D graphics hardware, and in particular, to 2D rendering on 3D graphics hardware by forming the 3D object using the 2D object.

### BACKGROUND

Users continue to demand more and more graphics for all aspects of computing. Often, computer application need to render 2D graphic objects, but often modern computer systems only have 3D graphics hardware available to render the 2D graphic objects.

### SUMMARY OF EMBODIMENTS

Therefore, there is a need in the art for an apparatus, computer readable medium, and method of rendering a 2D object using a 3D graphics processing unit (GPU).

The method includes one or more shaders running on the 3D GPU forming a 3D object by accessing the 2D object.

The method may include one or more shaders running on the 3D GPU forming a 3D object by forming a plurality of 3D vertex positions of the 2D object by accessing the 2D object.

The method may include one or more shaders running on the 3D GPU forming a 3D object by forming a plurality of 3D vertex attributes of the 2D object by accessing the 2D object.

The 3D vertex attributes may include texture coordinates, colors, or positions.

The method may include copying the 2D object from a central processing memory (CPU) to a GPU memory, and the one or more shaders running on the 3D GPU forming a 3D object by forming a plurality of 3D vertex positions of the 2D object by accessing the 2D object from the GPU memory.

The method may include copying a plurality of the 2D objects from a central processing memory (CPU) to a GPU memory; and, one or more shaders running on the 3D GPU forming the 3D object by forming a plurality of 3D vertex positions of the 2D object of the plurality of 2D objects by accessing the 2D object from the GPU memory.

The method may include the one or more shaders running on the 3D GPU forming a 3D object by converting the 2D object into a 3D object by accessing the 2D object.

Each of the one or more shaders may be executed by a single instruction multiple data (SIMD) processor of the GPU. The method may include displaying the 2D object using the 3D GPU.

The 2D object may be a rectangle. The 2D object may be a polygon.

The method may include the one or more shaders performing rendering effects on the formed 3D object.

A 2D rendering device is disclosed. The 2D rendering device may include a 3D graphic processing unit (GPU) and one or more shaders configured to execute on the 3D GPU and configured to form a 3D object by accessing the 2D object.

The 2D rendering device may include a central processing unit (CPU), a first memory, and a second memory. The CPU may be configured to copy one or more 2D objects from the first memory to the second memory, and the one or more shaders may be configured to access the 2D object from the second memory.

The one or more shaders may be further configured to form a plurality of 3D vertex attributes of the 2D object.

The 3D GPU may include a plurality of single instruction multiple data (SIMD) processors, and each of the one or more shaders may be further configured to execute on a different SIMDs of the plurality of SIMD processors.

A computer readable non-transitory medium including instructions which when executed in a processing system cause the processing system to execute a method for 2D rendering, the method comprising one or more shaders running on the 3D GPU forming a 3D object by forming a plurality of 3D positions of the 2D object by accessing the 2D object.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented; and

FIG. 2 illustrates a 2D rendering device according to some disclosed embodiments;

FIG. 3 illustrates a method for converting the 2D object into a 3D object by a shader;

FIG. 4 illustrates the operation of the method illustrated in FIG. 3 according to some disclosed embodiments;

FIG. 5 illustrates a method of rendering a 2D object using a 3D graphics processing unit (GPU) according to some disclosed embodiments; and

FIG. 6 illustrates a method of converting a 2D object into a 3D object.

### DETAILED DESCRIPTION OF EMBODIMENTS

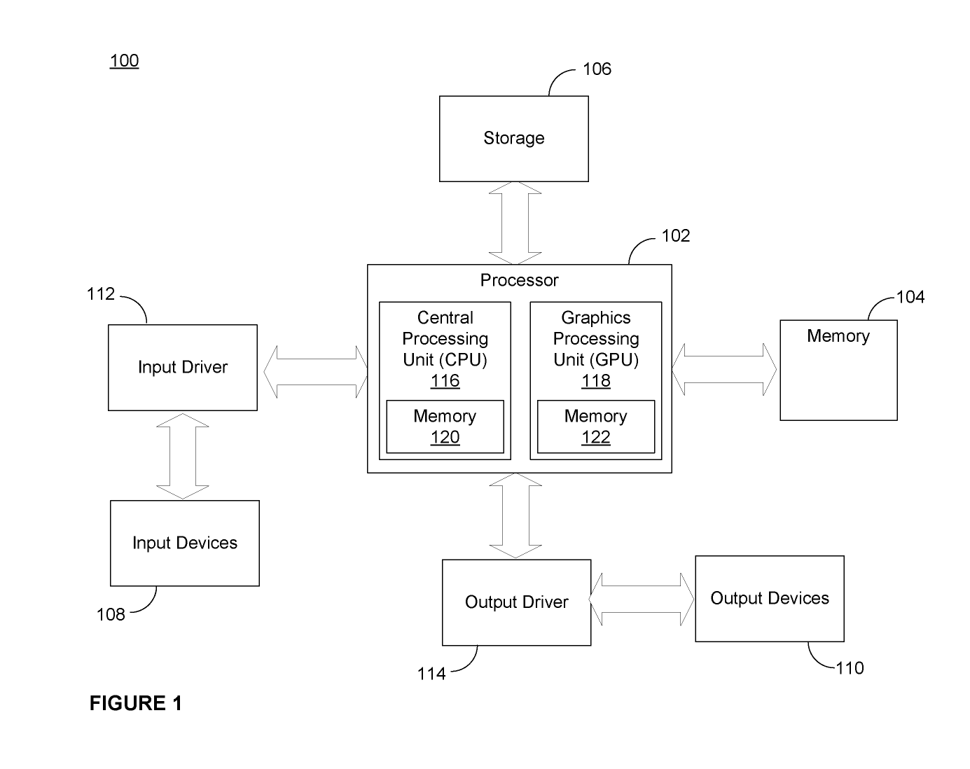

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU) 116, a graphics processing unit (GPU) 118, which may be located on the same die or different dies. The CPU 112 may include a memory 120 and one or more processor cores (not illustrated). Each of the processor cores may itself be a CPU or a GPU. The memory 120 may be a memory that is only accessible to the CPU 116 or it may be a shared memory accessible by other components of the system 100 such as the GPU 118. The GPU 118 may include a memory 122 which may be accessible only to the GPU 118 or it may be a shared memory accessible by other components of the system 100 such as the CPU 116.

The memory 104 may be located on the same die as the processor 102, or may be located separately from the processor 102. The memory 104 may include a volatile or non-volatile memory, for example, random access memory (RAM), dynamic RAM, or a cache. The memory 104 may include a cache (not illustrated) which may be a type of storage that may have faster access times than other portions of the memory 104.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

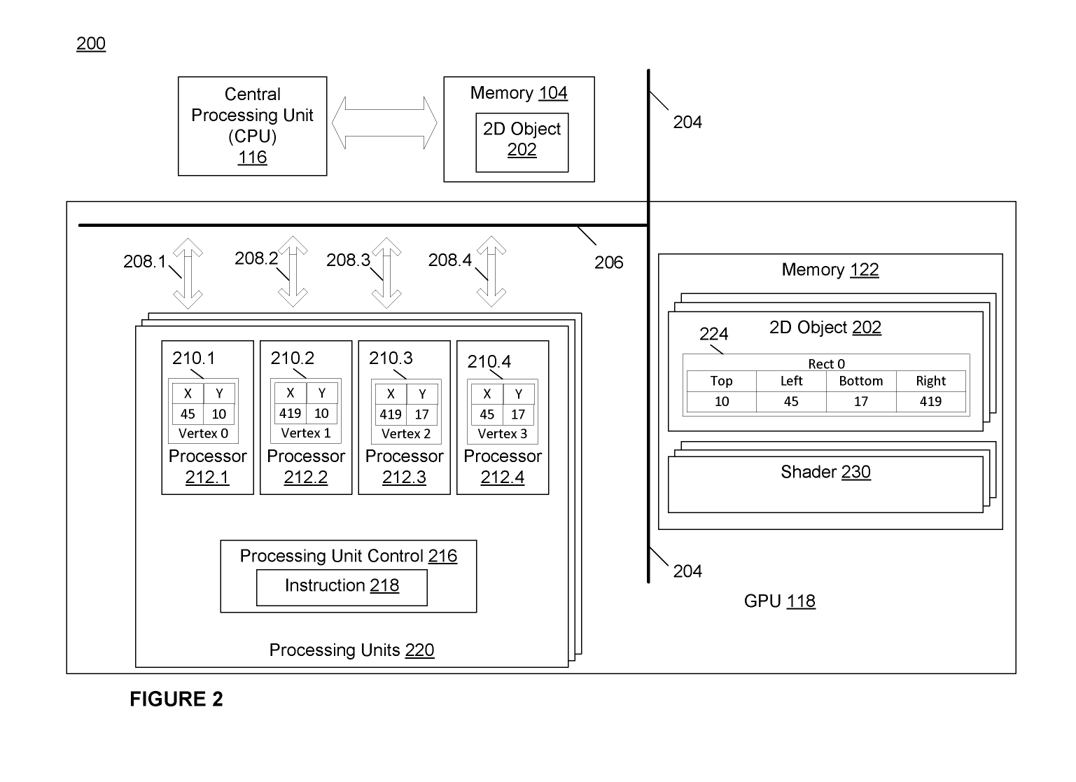

FIG. 2 illustrates a 2D rendering device according to some disclosed embodiments. Illustrated in FIG. 2 is a CPU 116, a memory 104, a bus 204, and a GPU 118. Shaders 230 form a 3D object 210 for rendering by accessing the 2D object 202. In some embodiments, the CPU 116 may copy the 2D object from the memory 104 to the memory 122 for access by the shaders 230. In some embodiments, the shaders 230 may access the 2D object in the memory 104. The CPU 116 may be a CPU 116 as discussed above. The memory 104 may be a memory as discussed above, which may include a representation of a 2D object 202. The bus 204 may be a bus 204 for communication among the CPU 116 and memory 104 and the GPU 118.

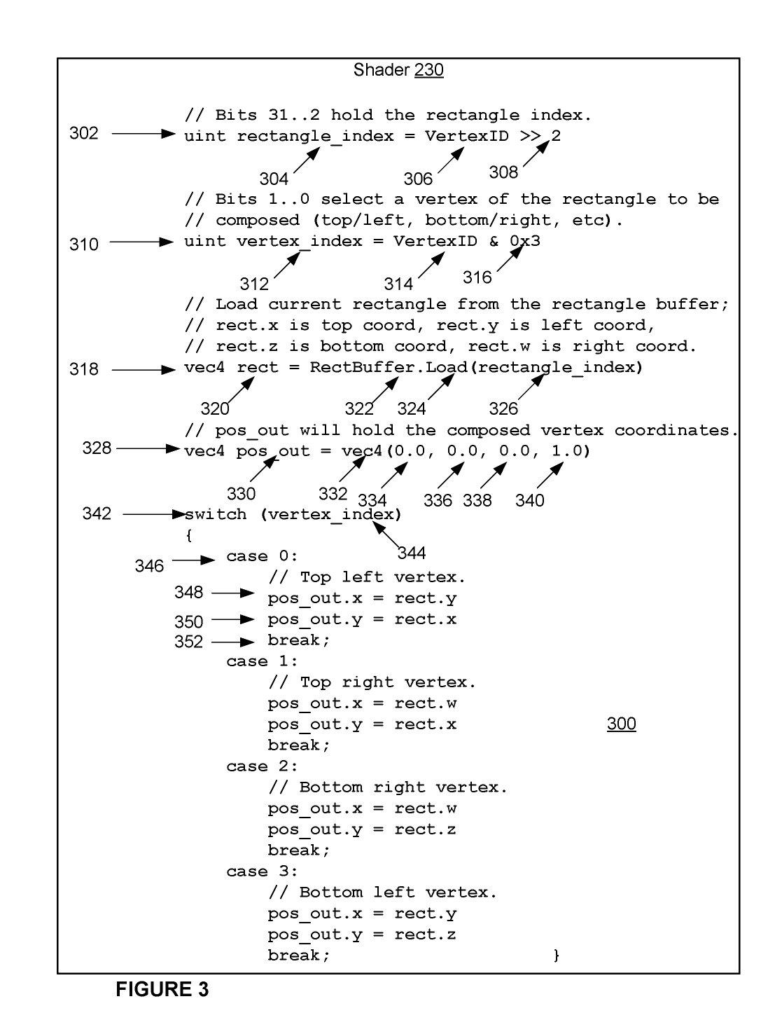

The GPU 118 may include a bus 206, processing units 220, memory 122, and a shader 230. The bus 206 may be a communication bus for the processing units 220, shader 230, and memory 122 to communicate with one another. The processing units 220 may include processors 212, processing unit control 216. The processors 212 may be single instruction multiple data (SIMD) units. The processing unit control 216 may control the operation of the processors 212. Each of the processors 212 may execute the same instruction 218 at the same time with different data. As illustrated, each of the processors 212 is forming a portion of a 3D object 210 from the 2D object 202. The processors 212 may access memory 122 using the bus 206 with memory requests 208. The memory 122 may be a memory associated with the GPU 118 as discussed above. The shader 230 may be configured to perform shader operations on the 2D object 202 by forming the 3D object of the 2D object 202 by accessing the 2D object 202. The shader 230 and 3D object 210 are discussed further in conjunction with FIG. 3.

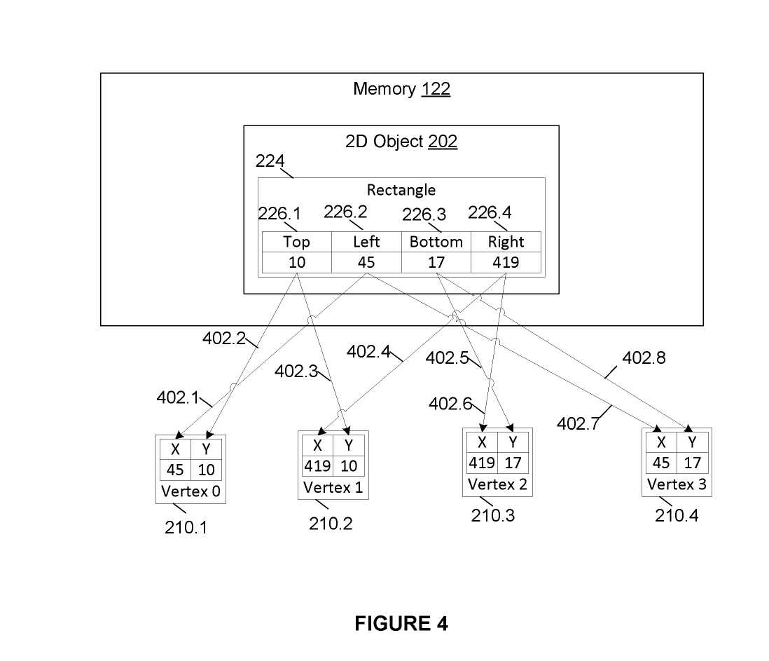

FIG. 3 illustrates a method for forming a 3D object by a shader of a 2D object. FIG. 4 illustrates the operation of the method illustrated in FIG. 3 according to some disclosed embodiments. FIG. 3 will be explained in conjunction with FIGS. 2 and 4. The “//” in FIG. 3 indicate that the line is a comment line. The shader 230 may access the 2D object 202 and form a 3D object 210 of the 2D object 202. The method 300 may begin with rectangle_index 304 being set to VertexID 306 shifted over 2 bits 302. VertexID 306 may be the lone invariant between the SIMDs executing the same shader 230. The top 30 bits of VertexID 306 may select a rectangle 224 from the 2D objects 202 and the bottom two bits of VertexID 306 may select which vertex 226 (FIG. 4) of the rectangle 224. The rectangle_index 304 is then a pointer to the rectangle 224 after 302. The method 300 may continue with vertex_index 312 being set to VertexID 314 logically and'ed with “0×3” 316 at 310. Vertex_index 312 then selects the vertex 226 of the rectangle 224. The method 300 continues with rect 320 set to RectBuffer.Load(rectangle_index) at 318. The RectBuffer 322 may be a buffer where the rectangles 224 are stored. The RectBuffer 322 may have been copied to memory 122 by the CPU 116 or another component of the system 200. After 318 rect 320 will point to the rectangle 224, or in some embodiments contain the rectangle 224. The method 300 continues with pos_out 330 being set to vec4(0.0, 0.0, 0.0, 1.0) at 328. Pos_out 330 is used to form the 3D vertices of the 2D rectangle 224. The 0.0 338 and the 1.0 340 are extra dimensions not used for forming the 3D rectangle 224 of the 2D object 202.

The method 300 may continue with switch(vertex_index) 344 at 342. If the value of vertex_index is zero, the method 300 may continue with case 0 at 346. The method 300 may continue with pos_out.x=rect.y at 348. For example, referring to FIG. 4, vertex 0 210.1 is being formed. Pos_out.x=rect.y is x 210.1 being assigned 402.1 the value of left 226.2 from rectangle 224. X 210.1 is set to 45 from the left 226.2. The method 300 may continue with pos_out.y=rect.x at 350. For example, Y 210.1 is set to top 226.1 so that the Y 210.1 has the value of 10. Vertex 0 210.1 is finished being formed. Vertex 210.1 may then be formed. The vertex 210.1 may be formed in the memory 122. Similarly, vertices 210.2, 210.3, and 210.4 may be formed so that portions of the 3D object 210 of the 2D object 202 may be formed so that the 2D object 202 may be rendered by the 3D GPU 118. The shader 230 may continue the method 300 by transforming the vertices, which may change the values of the pos_out vectors 330.

In some embodiments, each portion of the switch 344 may be performed by a different processor 212.1. In some embodiments, conditional operators are used rather than a switch statement in the example of FIG. 3, which may reduce the number of branches. In some embodiments, other attributes of the 2D object 202 are converted to the 3D object 210 in a similar fashion as illustrated in FIG. 3. For example, texture coordinates or colors based on source rectangles 224 may be formed for the 3D object 210 from the 2D object 202. In some embodiments, the 2D object 202 may be accessed by the shader 230 in the memory 104. In some embodiments, the shader 230 may be implemented by the CPU 116. In some embodiments, the shader 230 may be implemented by a circuit. In some embodiments, the shader 230 may be stored in a ROM memory.

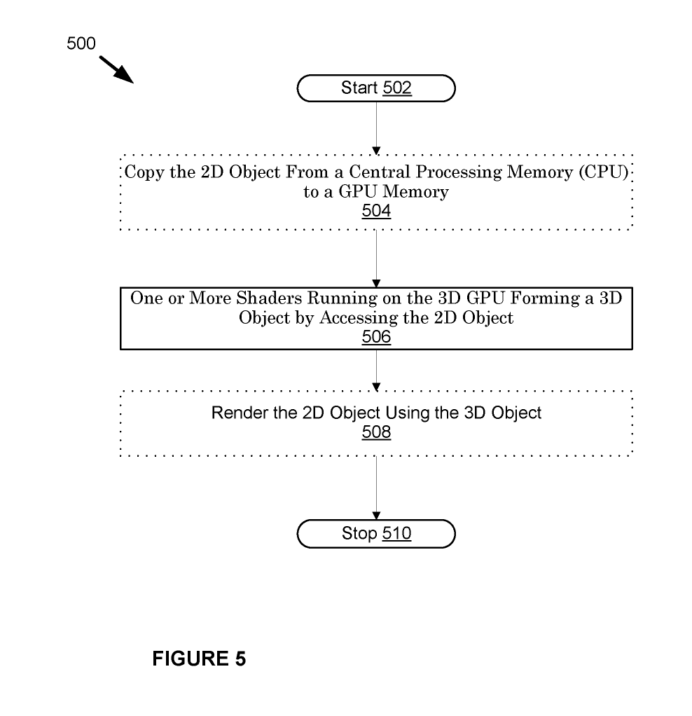

FIG. 5 illustrates a method of rendering a 2D object using a 3D graphics processing unit (GPU) according to some disclosed embodiments. The method 500 may begin with start 502. The method 500 may optionally continue with copying the 2D object from a central processing unit (CPU) to a GPU memory at 504. For example, referring to FIG. 2, the CPU 116 may copy one or more 2D objects 202 from the memory 104 to the memory 122.

The method may continue with one or more shaders running on the 3D GPU forming a 3D object of the 2D object by accessing the 2D object at 506. For example, again referring to FIG. 2, the shader 230 may access the 2D object 202 to convert the vertices of the 2D object 202 to vertices of a 3D object 210 by accessing the 2D object 202. In some embodiments, the shader 230 may access the 2D object in memory 122 or memory 104. In some embodiments, the shader 230 may use the processing units 220 for converting the 2D object 202 to a 3D object 310. The method 500 may continue with rendering the 3D object at 508. For example, after the shader 230 has formed the 3D object 210 of the 2D object, the shader 230 may call a rasterizer and display the 2D object 202 using the 3D object 210. The method may stop at 510. In some embodiments, the 2D object 202 may include many rectangles 224, and may include other information such as texture.

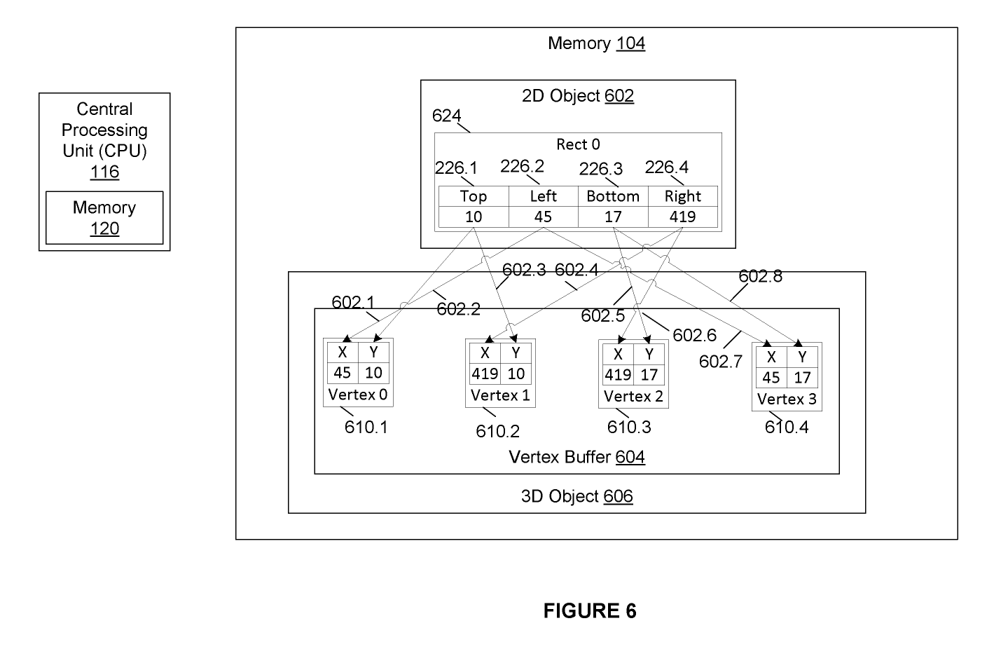

FIG. 6 illustrates a method of converting a 2D object into a 3D object. The CPU 116 may convert the 2D object 602 to a 3D object 606. For example, the 2D object 602 may be represented by a rectangle 624 with top 226.1, left 226.2, bottom 226.3, and right 226.4. The CPU 116 may convert the rectangle 624 into four vertices 610 in a format that is compatible with the 3D GPU 118. The vertices 610 may be formed as indicated in FIG. 6. For example, vertex 610.2 is formed by setting X 610.2 to right 226.4 which has a value of 419 at 602.4, and by setting Y 610.2 to top 226.1 which has a value of 10 at 602.3. The vertex buffer 604 takes twice the space as the rectangle 624 and may require the CPU 116 to form the vertices 610.

Some disclosed embodiments have the advantage that the representation of the 2D object is not converted into a 3D object representation in memory for the shaders to access the 3D object representation. By not converting the 2D object to a 3D object memory space is saved, and processing time is reduced.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the present invention.

The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). The computer-readable storage may be non-transitory.

What is claimed is:

1. A method of rendering a 2D object using a 3D graphics processing unit (GPU), the method comprising:
one or more shaders running on the 3D GPU forming a 3D object by accessing the 2D object.

2. The method of claim 1, wherein one or more shaders running on the 3D GPU forming a 3D object by accessing the 2D object comprises:
one or more shaders running on the 3D GPU forming a 3D object by forming a plurality of 3D vertex positions of the 2D object by accessing the 2D object.

3. The method of claim 1, wherein one or more shaders running on the 3D GPU forming a 3D object by accessing the 2D object comprises:
one or more shaders running on the 3D GPU forming a 3D object by forming a plurality of 3D vertex attributes of the 2D object by accessing the 2D object.

4. The method of claim 3, wherein the 3D vertex attributes is at least one of texture coordinates, colors, or positions.

5. The method of claim 1, further comprising:
copying the 2D object from a central processing memory (CPU) to a GPU memory; and, wherein one or more shaders comprises:
one or more shaders running on the 3D GPU forming a 3D object by forming a plurality of 3D vertex positions of the 2D object by accessing the 2D object from the GPU memory.

6. The method of claim 1, further comprising:
copying a plurality of the 2D objects from a central processing memory (CPU) to a GPU memory; and, wherein one or more shaders comprises:
one or more shaders running on the 3D GPU forming the 3D object by forming a plurality of 3D vertex positions of the 2D object of the plurality of 2D objects by accessing the 2D object from the GPU memory.

7. The method of claim 1, wherein the one or more shaders running on the 3D GPU forming a 3D object by accessing the 2D object comprises:
the one or more shaders running on the 3D GPU forming a 3D object by converting the 2D object into a 3D object by accessing the 2D object.

8. The method of claim 1, wherein each of the one or more shaders is executed by a single instruction multiple data (SIMD) processor of the GPU.

9. The method of claim 1, further comprising:
displaying the 2D object using the 3D GPU.

10. The method of claim 1, wherein the 2D object is a rectangle.

11. The method of claim 1, wherein the 2D object is a polygon.

12. The method of claim 1, further comprising:
the one or more shaders performing rendering effects on the formed 3D object.

13. A 2D rendering device, the device comprising:
a 3D graphic processing unit (GPU); and
one or more shaders configured to execute on the 3D GPU and configured to form a 3D object by accessing the 2D object.

14. The 2D rendering device of claim 13, further comprising:
a central processing unit (CPU);
a first memory; and
a second memory, wherein the CPU is configured to copy one or more 2D objects from the first memory to the second memory, and wherein the one or more shaders are configured to access the 2D object from the second memory.

15. The 2D rendering device of claim 13, wherein the 3D GPU comprises a plurality of single instruction multiple data (SIMD) processors.

16. The 2D rendering device of claim 15, wherein each of the one or more shaders are further configured to execute on a different SIMDs of the plurality of SIMD processors.

17. The 2D rendering device of claim 13, wherein the object is a rectangle.

18. The 2D rendering device of claim 13, wherein the one or more shaders are further configured to form the 3D object by forming a plurality of 3D vertex attributes of the 2D object.

19. The 2D rendering device of claim 13, wherein the 3D vertex attributes is at least one of texture coordinates, colors, or positions.

20. A computer readable non-transitory medium including instructions which when executed in a processing system cause the processing system to execute a method for 2D rendering, wherein the method comprises: one or more shaders running on the 3D GPU forming a 3D object by forming a plurality of 3D index vertices of the 2D object by accessing the 2D object.
